(19) United States
(12) Patent Application Publication
(10) Pub. No.: US 2026/0222512 A1
(43) Pub. Date: Jul. 30, 2026

(54) IMAGE CONVERSION METHOD, IMAGE CONVERSION DEVICE, AND IMAGE CONVERSION PROGRAM

(71) Applicant: ANNY INC., Tokyo (JP)

(72) Inventors: Tetsuo SUZUKA, Tokyo (JP); Kyoko SUZUKA, Tokyo (JP)

(73) Assignee: ANNY INC., Tokyo (JP)

(21) Appl. No.: 19/148,250

(22) PCT Filed: Jan. 29, 2024
(86) PCT No.: PCT/JP2024/002612

§ 371 Date: Jul. 15, 2025

(30) Foreign Application Priority Data
Jan. 30, 2023 (JP) 2023-011561

(51) Int. Cl. H04N 1/60; G06T 7/11; G06T 7/90

(52) U.S. Cl. CPC H04N 1/6005; G06T 7/11; G06T 7/90; G06T 2207/10024

(57) ABSTRACT

The image conversion method converts a raster format to a vector format. The image conversion method comprising: dividing an input image in a raster format into a plurality of divided regions having a predetermined size; using the luminance of red, green, and blue of all pixels in the divided region to calculate respective luminance averages for red, green, and blue in the divided region; providing three single-color regions of red, green, and blue within the divided region; changing the sizes of the single-color regions of red, green, and blue, respectively, according to the luminance averages of red, green, and blue in the divided region; and generating and outputting an image data in a vector format using the single-color regions of red, green, and blue.

### TECHNICAL FIELD

This invention relates to an image conversion device, an image conversion method and an image conversion program.

### BACKGROUND ART

One of the known formats of displaying images on a computer is a format called raster format. In the raster format, the RGB (red-green-blue) luminance gradation is changed for each pixel lined up in a grid pattern to display a color image as a whole. In order to expand the range of expression of images displayed in such a raster format, software that converts the display mode is widely used (e.g., Patent Document 1).

### PRIOR ART DOCUMENTS

### Patent Literature

Patent Document 1: JP2022-517836A1

### SUMMARY OF INVENTION

### Technical Problem

Inkjet and silkscreen printing are known as methods for painting a computer-generated image onto a print target in the real world. Of these methods, silkscreen printing is known for its wide range of expression, such as the ability to print on a variety of materials, good ink color development, and the ability to use inks that are not possible with inkjet printing, making it suitable for use in cases where high expressiveness is required, such as art. Generally, when painting with silkscreen printing, a plate is created for each color, such as CMYK (cyan, magenta, yellow, and black), based on the image, and color printing is performed with a different color for each plate.

However, since an image displayed in raster format is expressed based on the luminance of RGB, colors other than the three colors of RGB may be used, so it is difficult to create a silk screen plate that accurately reproduces colors. Even if various expression methods are used as in the technology of Patent Document 1, since it is raster format image data, the color reproducibility in painting is not high. Furthermore, when a raster format image is used for silk screen painting, the color boundaries (edges) are not clear when painting with silk screen compared to a vector format in which the shape and color of the components in the image are described in XML format. Therefore, the development of a method for converting an input image in raster format to a vector format is expected.

The present invention has been made in view of the above problems, and has an object to provide an image conversion method, an image conversion device and an image conversion program for converting an input image in raster format into a vector format.

### Solution to Problem

The image conversion method of the present invention is an image conversion method for converting a raster format into a vector format. According to this method, an input image represented in a raster format is divided into a plurality of divided regions having a predetermined size; respective luminance averages for red, green, and blue in a divided region are calculated using the luminance of red, green, and blue of all pixels in the divided region; three single-color regions of red, green, and blue are provided within the divided region; the sizes of the single-color regions of red, green, and blue are changed, respectively, according to the luminance averages of red, green, and blue in the divided region; and image data in a vector format is generated and output using the single-color regions of red, green, and blue.

The image conversion device of the present invention is an image conversion device for converting a raster format into a vector format. This image conversion device comprises a division unit that divides an input image represented in a raster format into a plurality of divided regions of a predetermined size; a single-color conversion unit that calculates respective luminance averages for red, green, and blue in a divided region using the luminance of red, green, and blue of all pixels in the divided region, provides three single-color regions of red, green, and blue in the divided region, and changes the sizes of the single-color regions of red, green, and blue, respectively, according to the luminance averages of red, green, and blue in the divided region; and an output unit that generates and outputs image data in a vector format using the single-color regions of red, green, and blue.

The image conversion program of the present invention is a image conversion program for converting a raster format into a vector format. The program causes a processor to: divide an input image in a raster format into a plurality of divided regions having a predetermined size; use the luminance of red, green, and blue of all pixels in the divided region to calculate respective luminance averages for red, green, and blue in the divided region; provide three single-color regions of red, green, and blue within the divided region; change the sizes of the single-color regions of red, green, and blue, respectively, according to the luminance averages of red, green, and blue in the divided region; and generate and output an image data in a vector format using the single-color regions of red, green, and blue.

### Effects of the Invention

According to the image conversion method, image conversion device and the recording medium on which the image conversion program is recorded of the present invention, a raster format image is divided into a plurality of divided regions, and three single-color regions of red, green, and blue are provided in each of these divided regions. The sizes of the corresponding single-color regions are then changed according to the luminance averages of red, green, and blue in the divided regions, and image data in a vector format representing these single-color regions are generated. In this way, it is possible to convert image data from raster format to vector format while maintaining the display content of the image as a whole in a distinguishable manner.

### BRIEF DESCRIPTION OF DRAWINGS

FIG. 1 is a schematic diagram of the hardware of an image conversion device according to a first embodiment.

FIG. 2 is a schematic diagram of the software of the image conversion device.

FIG. 3 is a diagram showing a flowchart of image conversion processing.

FIG. 4 is a diagram showing a detailed flowchart of step S35 in FIG. 3.

FIG. 5 is an explanatory diagram of image conversion processing.

FIG. 6 is a diagram showing an image after image conversion processing.

FIG. 7 is an explanatory diagram of image conversion processing according to a second embodiment.

FIG. 8 is an explanatory diagram of image conversion processing according to a third embodiment.

FIG. 9 is an explanatory diagram of image conversion processing according to a fourth embodiment.

FIG. 10 is an explanatory diagram of pre-processing according to a fifth embodiment.

### DESCRIPTION OF EMBODIMENTS

An embodiment of the present invention will be described in detail with reference to the drawings below. In the following description, the same components are given the same reference numerals, and duplicated descriptions will be omitted.

### First Embodiment

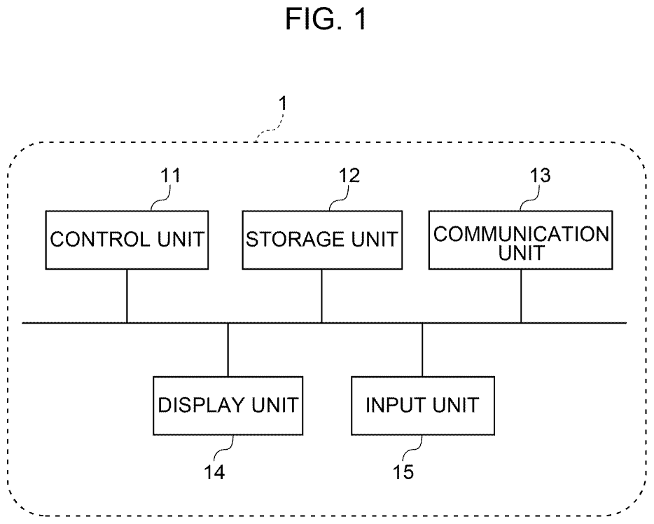

FIG. 1 is a schematic diagram of the hardware configuration of an image conversion device of this embodiment. Image conversion device 1 is, for example, a device such as a personal computer, which performs a predetermined conversion process on an input image in raster format, and generates and outputs image data in vector format to be used for painting such as silk screen printing.

In detail, the image conversion device 1 includes a control unit 11 consisting of a CPU (Central Processing Unit) and a GPU (Graphics Processing Unit) that controls the entire device; a storage unit 12 consisting of a ROM (Read Only Memory), a RAM (Random Access Memory), and/or a hard disk, which stores programs and various data; a communication unit 13 that communicates with the outside; a display unit 14 that displays data on an information display device such as a touch panel; and an input unit 15 that accepts input from a device such as a touch panel.

The control unit 11, storage unit 12, communication unit 13, display unit 14, and input unit 15 are configured to be able to communicate with each other. The image conversion device 1 is configured to be able to execute a predetermined process by executing a program recorded in the storage unit 12. The hardware configuration of the image conversion device 1 shown in this figure is one example, and it is sufficient that the predetermined process is executed by operating the stored program.

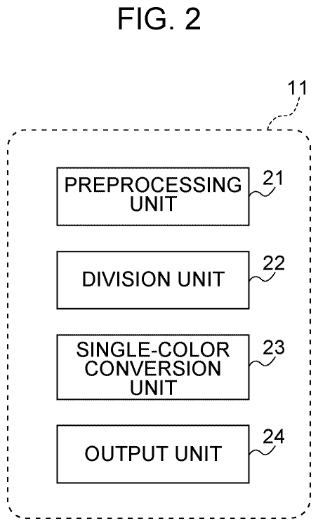

FIG. 2 is a schematic diagram of the functional blocks in the control unit 11. A specific program is stored in the control unit 11, and the control unit 11 performs specific processing by executing the stored program. The control unit 11 includes a preprocessing unit 21, a division unit 22, a single-color conversion unit 23, and an output unit 24. Note that the software configuration shown in FIG. 2 is an example, and these processes may be performed by one processor, or multiple processors or microcomputers may perform the processes corresponding to each block.

The preprocessing unit 21 accepts input of parameters required for the conversion process, and also accepts input of raster-format image data to be converted, and performs preprocessing such as converting the size and resolution of the accepted image data.

The division unit 22 divides the image preprocessed by the preprocessing unit 21 into a plurality of divided regions having a predetermined size. This results in multiple divided regions.

The single-color conversion unit 23 performs single-color conversion processing on each of the divided regions generated by the division unit 22, converting the divided region into three single-color regions displayed in the single colors of red, green, and blue (RGB). This single-color conversion processing provides, within each divided region generated by the division unit 22, a plurality of single-color regions corresponding to each color of RGB: a single-color region (red (R)), a single-color region (green (G)), and a single-color region (blue (B)).

The output unit 24 uses the single-color regions generated by the conversion processing by the single-color conversion unit 23 to generate and output vector format image data that is descriptively described (for example, using the extensible markup language (XML format)). The vector format image data can then be used for silk screen painting.

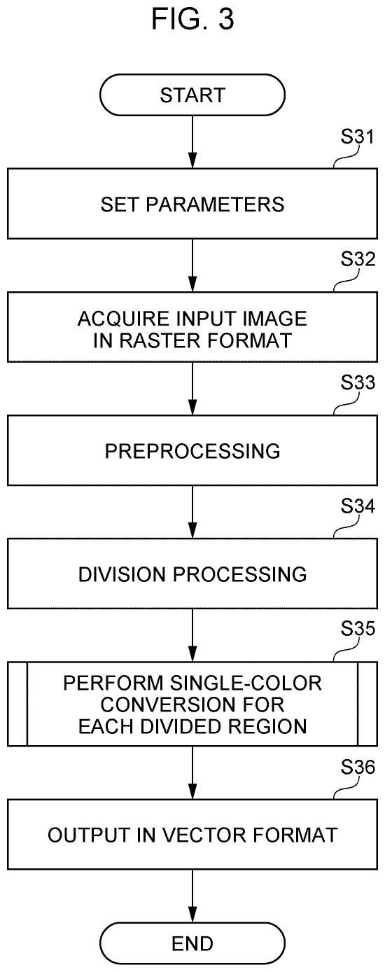

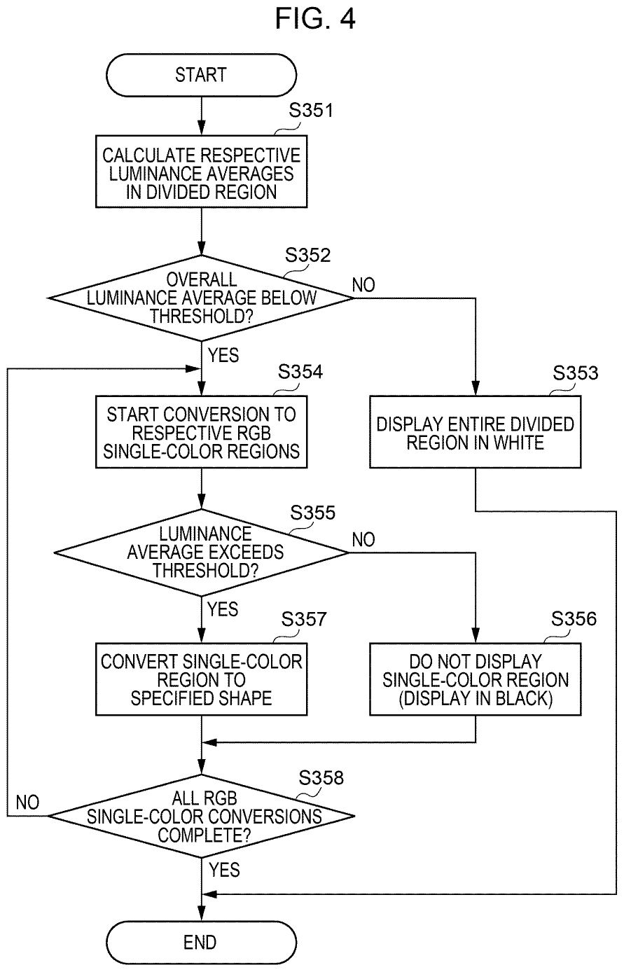

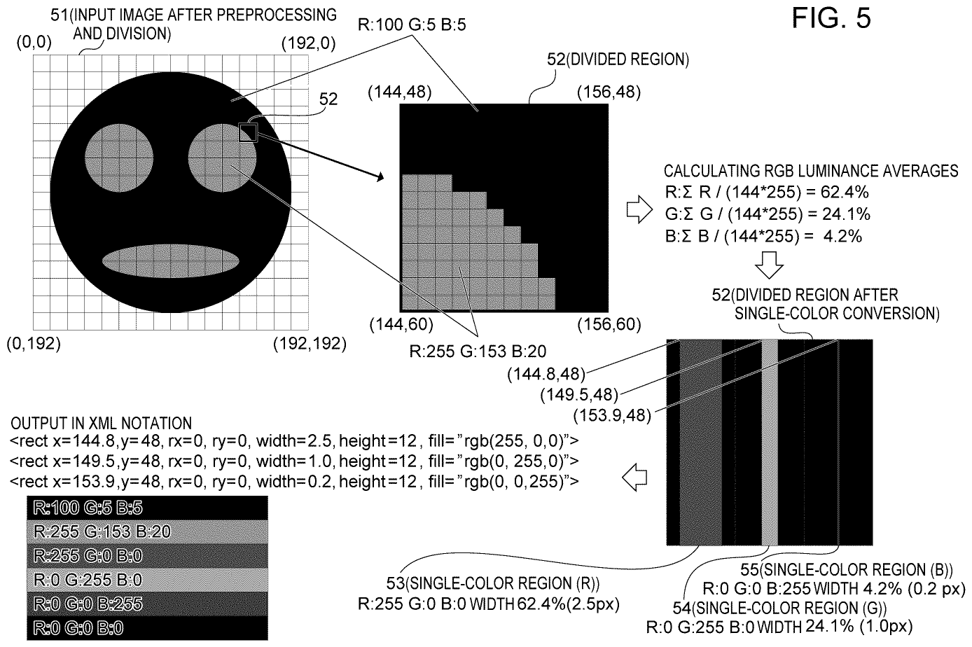

FIGS. 3 and 4 are flowcharts showing a series of processes performed by the pre-processing unit 21, the division unit 22, the single-color conversion unit 23, and the output unit 24 in the control unit 11. FIG. 5 is an explanatory diagram of the image conversion process. Details of the image conversion process will be explained below using FIGS. 3 to 5.

As shown in FIG. 3, in step S31, the pre-processing unit 21 accepts the setting of parameters to be used in the processing described below. The parameters to be set include the following:
luminance correction command value
Shape of the divided region
Size of the divided region (length and width)
Whitening setting of the divided region (threshold value)
Shape and size of the single-color region
Conversion method of the single-color region (variable vertically and horizontally)
Minimum display size of the single-color region (threshold value)
Insertion line setting (Presence/absence of insertion line, insertion direction, interval, width)

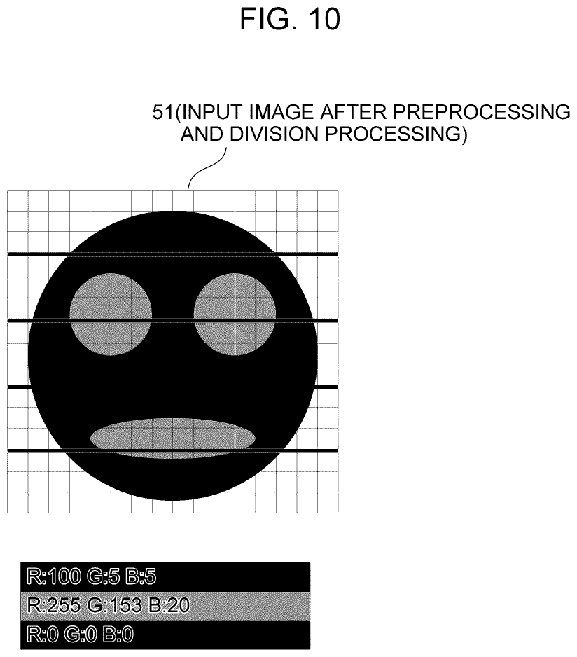

Among these settings, the luminance correction command value is used in preprocessing by the preprocessing unit 21 (step S33). The parameters related to the divided regions are used in division processing by the division unit 22 (step S34). The parameters related to the single-color regions are used in single-color conversion processing by the single-color conversion unit 23 (step S35). The parameters related to Insertion line are used in preprocessing by the preprocessing unit 21 (step S33) and division processing by the division unit 22 (step S34). Note that the processing related to Insertion line will be described in detail in the fifth embodiment using FIG. 10.

In step S32, the preprocessing unit 21 acquires an input image in raster format to be converted. The input image may be an image stored in the image conversion device 1, or may be an image stored outside the image conversion device 1 and acquired via the communication unit 13.

In step S33, the preprocessing unit 21 performs preprocessing for subsequent processing on the image input in step S32. First, the preprocessing unit 21 adjusts the overall luminance based on the luminance correction command value that is set. For example, when the luminance correction command value is 120%, the luminance of all the pixels that make up the input image is multiplied by 1.2 (one point two).

In the subsequent division process of step S34, the input image is divided into multiple divided regions based on the shape and size of the set divided regions. Therefore, the preprocessing unit 21 enlarges the input image and adds or removes margins so that the length and width of the input image are integral multiples of the length and width of the divided regions. This makes it less likely that parts will not be included in the divided regions in the division process of step S34.

In step S34, the division unit 22 divides the image preprocessed in step S32 into multiple divided regions of a predetermined size.

For example, the input image 51 after preprocessing is shown in the upper left of FIG. 5. Note that in this figure, the size and position of the image are shown in units of pixels (px). The input image 51 after preprocessing is assumed to be 192px in both the vertical and horizontal directions. In these figures, coordinates (x, y) are used such that the upper left corner is the origin, and x is positive toward the right and y is positive toward the bottom. Therefore, the coordinates of the upper left corner of the input image 51 are (0, 0), the coordinates of the upper right corner are (192, 0), the coordinates of the lower left corner are (0, 192), and the coordinates of the lower right corner are (192, 192).

The division unit 22 divides the input image 51 based on the set shape and size. In the example shown in this figure, the division unit 22 divides the input image 51 into square divided regions 52 each of 12px in size. As a result of this division, a total of 256 divided regions 52 are generated, 16 vertically and 16 horizontally.

Referring again to FIG. 3, in step S35, the single-color conversion unit 23 provides three single-color regions (R) 53, (G) 54, and (B) 55 corresponding to RGB for each of the divided regions 52 generated in step S34, and changes their sizes. Details of the single-color conversion process performed in step S35 are shown in FIG. 4.

As shown in FIG. 4, in step S351, the single-color conversion unit 23 performs single-color conversion processing on each of the divided regions 52. In the example shown in FIG. 5, an example of single-color conversion is shown for the divided region 52 that is the thirteenth from the left and the fifth from the top. The coordinates of the upper left corner of this divided region 52 are (144, 48), the coordinates of the upper right corner are (156, 48), the coordinates of the lower left corner are (144, 60), and the coordinates of the lower right corner are (156, 60).

The single-color conversion unit 23 first calculates the luminance average for each of the RGB colors, which is expressed as a percentage, using all pixels present in the divided region 52. In this divided region 52, the luminance of each RGB element of the 89 pixels on the upper right side is R:100, G:5, B:5, and the luminance of each RGB element of the 55 pixels on the lower left side is R:255, G:153, B:20. The RGB luminance of each pixel is expressed in 256 gradations, using a range of 0 to 255.

The single-color conversion unit 23 calculates the sum of the luminance of each RGB element of all pixels in the divided region 52, divides the calculated sum by the number of pixels in the divided region 52 (144), and then divides the result by the maximum gradation of 255 to calculate the luminance average of each RGB element in the divided region. In this example, the luminance averages of each RGB element in the divided region 52 are 62.4%, 24.1%, and 4.2%, respectively.

In step S352, the single-color conversion unit 23 determines whether or not to display the entire divided region 52 in white, based on the whitening setting of the divided region 52. Specifically, the single-color conversion unit 23 calculates the average of the luminance average ratios of RGB in the divided region 52, and determines whether the average exceeds the set threshold.

In the example of FIG. 5, since the luminance averages of the RGB elements in the divided region 52 are 62.4%, 24.1%, and 4.2%, the average of these values, 30.3%, is calculated as the overall average. For example, if the threshold is 90%, the single-color conversion unit 23 next executes the process of S354 because the calculated average falls below the threshold (S352: Yes). If the average does not fall below the threshold (S352: No), the single-color conversion unit 23 next executes the process of S353.

In step S353, if the luminance ratio overall average in the divided region 52 is not below (does exceed) the threshold (S352: No), the single-color conversion unit 23 displays the entire divided region 52 in white (R:255 G:255 B:255) and ends the single-color conversion process for the divided region 52.

If the divided region 52 as a whole exceeds a predetermined luminance, the color reproducibility may not be improved when painting with a silk screen, even if the subsequent single-color conversion process is performed, and the divided region 52 may appear dull. Therefore, if the luminance ratio overall average in the divided region 52 exceeds the threshold, the divided region 52 is not subjected to single-color conversion, and the entire region is displayed in white. This makes it possible to prevent dullness when painting with a silk screen. Note that if whitening is not performed, the threshold is set to 100%.

In step S354, the single-color conversion unit 23 starts converting each of the RGB elements into predetermined single-color regions 53-55 according to the luminance ratio average calculated in step S351. The single-color conversion unit 23 first provides three single-color regions within the divided region 52: a single-color region (R) 53, a single-color region (G) 54, and a single-color region (B) 55.

In FIG. 5, the divided region 52 after single-color conversion processing is shown in the lower right. Within the divided region 52, vertically long rectangles (with the long direction being the y-axis) are created lined up horizontally as the single-color regions 53-55. The vertical height of these single-color regions 53-55 is fixed, and the horizontal width is variable. The processing of steps S355 to S357 is repeated for each element of RGB, and single-color region (R) 53, single-color region (G) 54, and single-color region (B) 55 are provided.

In step S355, the single-color conversion unit 23 determines whether or not to display single-color regions 53 to 55 based on the setting of the minimum display size of single-color regions 53 to 55. Specifically, the single-color conversion unit 23 determines whether the average luminance ratio of RGB in divided region 52 is equal to or less than a set threshold.

In the example of FIG. 5, the luminance averages of RGB are 62.4%, 24.1%, and 4.2%, respectively, and the threshold is, for example, 1%. Since all of the luminance averages of RGB exceed the threshold (S355: Yes), the single-color conversion unit 23 next executes the processing of S357. If an RGB luminance average does not exceed the threshold value (S355: No), the single-color conversion unit 23 next executes the process of S356 for the single-color regions 53 to 55 corresponding to the color elements that do not exceed the threshold value.

In step S356, the single-color conversion unit 23 ends the single-color conversion process without providing single-color regions 53-55 of color elements whose luminance average is below the threshold. Since the background of the image after the conversion process is black (R:0 G:0 B:0), the regions where single-color regions 53-55 are not provided are ultimately displayed in black.

If the luminance average of any of the RGB colors does not exceed the specified threshold (S355: No), the single-color regions 53-55 will be extremely small, falling below the printing limit or display limit when painting with a silk screen, and a clear representation cannot be obtained. Therefore, by omitting the display of single-color regions 53-55 whose luminance average is below the specified threshold, the corresponding regions will be displayed in black, which is the background color, and unclear representation can be prevented.

In step S357, the single-color conversion unit 23 determines single-color regions 53-55 according to the luminance average of RGB. In the example of FIG. 5, one divided region 52 includes three vertically long rectangular single-color regions 53-55, so the vertical length of the single-color regions 53-55 is fixed at 12px and the horizontal width is variable up to 4px.

The single-color conversion unit 23 determines the variable horizontal width of single-color region (R) 53, single-color region (G) 54, and single-color region (B) 55 by performing conversion according to the luminance average of each RGB element of 62.4%, 24.1%, and 4.2%. As a result, the widths of the single-color region (R) 53, single-color region (G) 54, and single-color region (B) 55 are 2.5px, 1.0px, and 0.2px, respectively. The single-color regions 53 to 55 converted in this way are horizontally centered in the locations obtained by dividing the divided region 52 into three.

In step S358, if conversion to single-color regions 53 to 55 has been completed for all RGB (S358: Yes), the single-color conversion process ends. If conversion to single-color regions 53 to 55 has not been completed for all RGB colors (S358: No), the single-color conversion unit 23 then proceeds to the process of step S354 and converts the remaining colors to single-color regions 53 to 55.

Through the above process, one divided region 52 is converted into single-color regions 53-55 according to the three color elements RGB. As shown in FIG. 3, once the single-color conversion process has been performed on all divided regions 52 in step S35, the process of step S36 is then performed.

In step S36, the output unit 24 creates an output file in a vector format that describes the converted single-color regions 53-55 of all divided regions 52 in a descriptive manner using XML or the like. The output file indicates the shapes, sizes, positions, etc. of the converted single-color regions (R) 53, single-color region (G) 54, and single-color region (B) 55 in all divided regions 52.

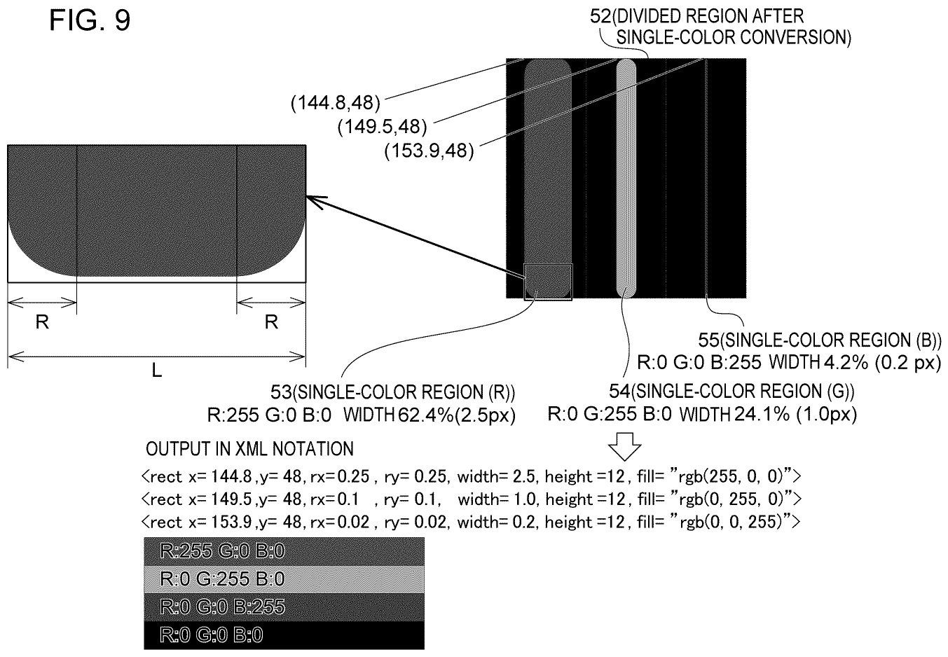

In the example of FIG. 5, the shape of the single-color regions 53-55 is a rectangle (rect), and the coordinates (x, y) of the origin side (upper left side) indicating the arrangement, the width and height (width, height) indicating the size, and the color (rgb) are descriptively shown. Specifically, the coordinates of the upper left of the single-color regions 53-55 are shown as (144.8, 48), (149.5, 48), and (153.9, 48), respectively. The sizes of the single-color regions 53-55 are 2.5px, 1.0px, and 0.2px in the horizontal direction (width direction), respectively, and 12px in the vertical direction (height direction), which is common to all of them. Note that the rectangle may have rounded corners, and parameters (rx, ry) that specify the roundness may be included. The setting of rounded corners will be explained in the fourth embodiment using FIG. 9 described later.

In the output data, the entire background is displayed in black (R:0 G:0 B:0). Therefore, the parts where the single-color regions 53 to 55 are not displayed are displayed in black (R:0 G:0 B:0).

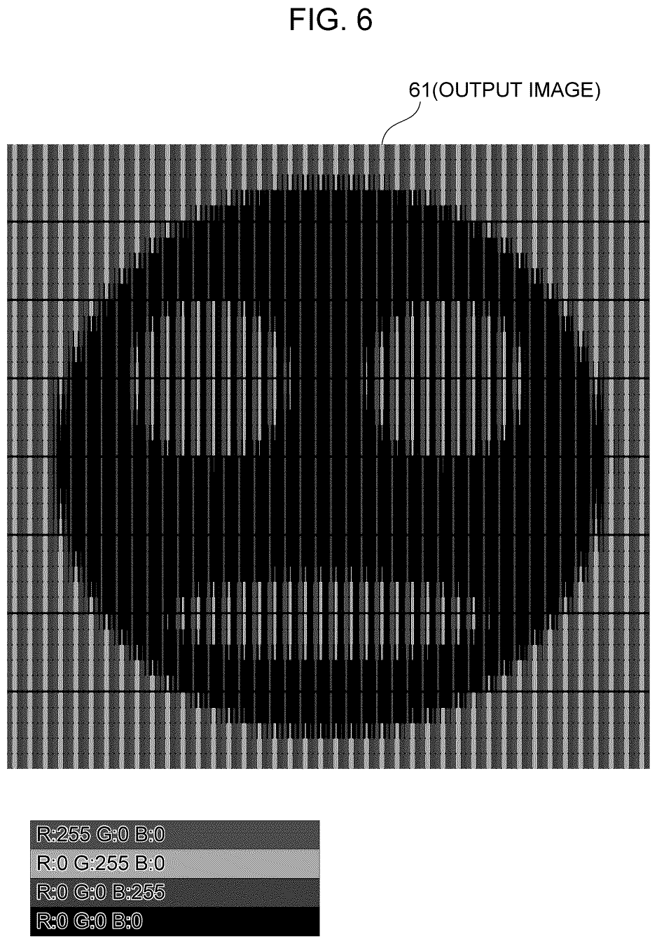

FIG. 6 shows an image obtained by converting the entire input image 51 shown in FIG. 5 into single-color regions. In this figure, for readability, only the horizontal lines indicating the divided regions 52 are shown, while the vertical lines are omitted. As shown in FIG. 6, the output image 61 that has undergone single-color conversion processing has RGB single-color regions 53 to 55 in each of the divided regions 52, but it can be seen that the overall display remains distinguishable.

Such image conversion provides the following effects. Since the image in raster format before conversion is expressed based on luminance, colors other than the three colors RGB are also used, resulting in low color reproducibility in painting, especially when silkscreen printing is used. In contrast, the image output in vector format after conversion is displayed in single colors RGB, so it is expected that color reproducibility will be high when the vector format output file is used for painting. Furthermore, by using the vector format, color boundaries (edges) during painting can be made clearer than with the raster format. This embodiment converts image data from raster format to vector format while maintaining the overall image in distinguishable form, making it possible to perform painting with high color reproducibility and clear boundaries.

### Second Embodiment

In the first embodiment, the single-color regions 53-55 are vertically long rectangular regions (the y-axis direction is the longitudinal direction), arranged side by side in the horizontal direction (the x-axis direction), and the horizontal width is changed according to the luminance average of RGB. In the second embodiment, the single-color regions 53-55 are vertically long rectangular regions similar to the first embodiment, but an example is described in which the vertical height is changed according to the luminance average of RGB.

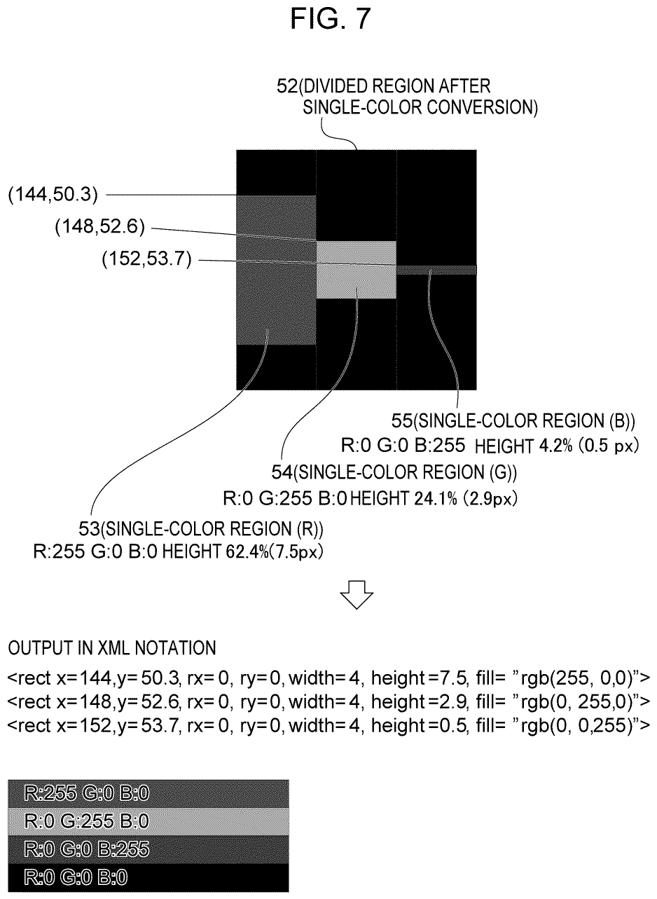

FIG. 7 is a diagram showing the divided region 52 after single-color conversion in the second embodiment. As shown in this figure, three vertically long rectangular RGB single-color regions 53-55 corresponding to RGB are provided side by side in the horizontal direction within the divided region 52. The height of these single-color regions 53-55 is changed according to the luminance average of RGB.

Specifically, the width of the RGB single-color regions 53-55 is fixed at 4px, and the vertical height is variable up to a maximum of 12px. Since the respective luminance averages of RGB are 62.4%, 24.1%, and 4.2%, the respective heights of the RGB single-color regions 53-55 are 7.5px, 2.9px, and 0.5px.

Furthermore, the single-color regions 53-55 converted in this way are vertically centered in their respective locations within the divided region 52. Therefore, the coordinates of the upper left corners of the single-color region (R) 53, single-color region (G) 54, and single-color region (B) 55 are (144, 50.3), (148, 52.6), and (152, 53.7), respectively. The coordinates and sizes of these single-color regions 53-55 are included in the output data.

In this way, the vertical height of the single-color regions 53-55 may be changed according to the luminance average. As a result, either the height or the width of the same vertically long rectangular single-color regions 53-55 may be changed, which widens the range of expression during painting.

### Third Embodiment

In the first and second embodiments, an example was described in which the single-color regions 53-55 are vertically long (the y-axis direction is the longitudinal direction). In the third embodiment, the single-color regions 53-55 are horizontally long rectangles (the x-axis direction is the longitudinal direction), and an example is described in which these single-color regions 53-55 are arranged vertically.

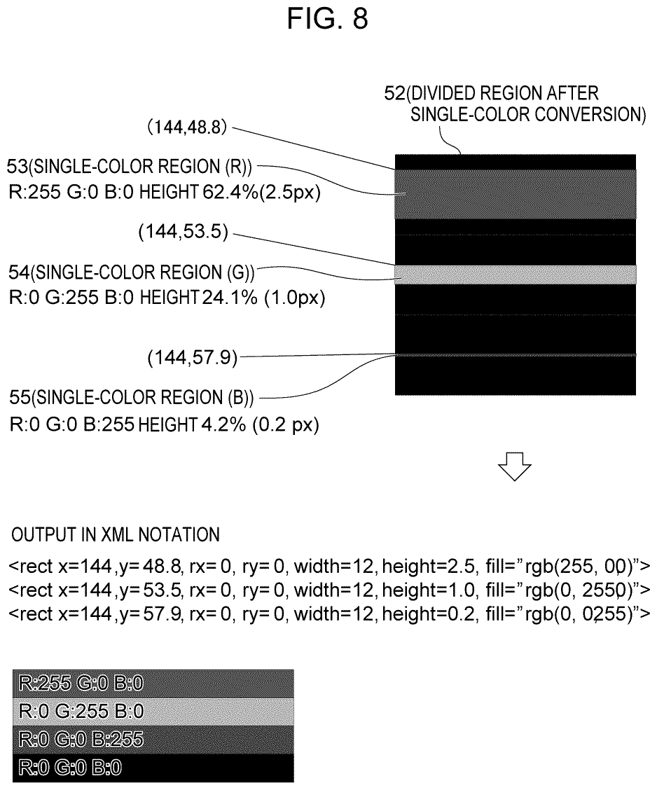

FIG. 8 is a diagram showing the divided region 52 after single-color conversion in the third embodiment. As shown in this figure, three horizontally long rectangular single-color regions 53-55 corresponding to RGB are provided in one divided region 52. The height of these single-color regions 53-55 is changed according to the luminance average of each RGB element.

Specifically, the width of the single-color regions 53-55 is fixed at 12px, and the height is variable up to 4px. As the respective luminance averages of RGB are 62.4%, 24.1%, and 4.2%, the respective heights of the RGB single-color regions 53-55 are 2.5px, 1.0px, and 0.2px.

The single-color regions 53-55 converted in this way are vertically centered in their respective locations within the divided region 52. Therefore, the coordinates of the upper left corners of the RGB single-color regions 53-55 are (144, 48.8), (144, 53.5), and (144, 57.9), respectively. The coordinates and sizes of these RGB single-color regions 53-55 are included in the output vector data.

In this way, the single-color regions 53-55 may be either vertically or horizontally long rectangles. By changing the rectangular shape of the single-color regions 53-55, the range of expression during painting can be expanded.

### Fourth Embodiment

In the first to third embodiments, an example was described in which the rectangular single-color regions 53-55 have sharp corners. In the fourth embodiment, an example will be described in which the four corners of the rectangular single-color regions 53-55 are rounded.

FIG. 9 is a diagram showing the divided region 52 after single-color conversion in the fourth embodiment. As shown in this figure, for the RGB single-color regions 53-55, the horizontal widths of the vertically long rectangular single-color regions 53-55 are changed according to the luminance average of RGB, as in the first embodiment.

This figure also shows an enlarged view of the bottom end of the single-color region (R) 53 on the left, and the radius that determines the curvature of the corner of the single-color region (R) 53 is determined according to a set value. Specifically, if the radius of the corner is R and the width of the single-color region (R) 53 is L, the ratio of the radius R to the width L (R/L) is set. Therefore, the value obtained by multiplying the width L of the single-color region (R) 53 by the set value becomes the radius R.

A descriptive representation of the radius R thus determined is included in the vector data. In this example, 10% of the width of the single-color regions 53-55 is set as the radius. Note that in the vector format, the roundness can be set independently for the x and y directions, but in this embodiment, it is assumed that 10% is set for both the x and y directions. As a result, in each of the RGB single-color regions 53-55, the same value is set for the roundness in the x-direction (rx) and the roundness in the y-direction (ry), resulting in 0.25px, 0.1px, and 0.02px, respectively.

In this way, since the single-color regions 53-55 can be made into rectangles with rounded corners, if the painting precision of corners with silkscreen is not high, providing rectangular single-color regions 53-55 with rounded corners in advance can enhance the reproducibility of shapes within the image during painting.

### Fifth Embodiment

In the first embodiment, an example was described in which the input image 51 is simply divided into 12 regions vertically and 12 regions horizontally. In the fifth embodiment, an example is described in which the input image 51 is divided after being preprocessed.

FIG. 10 is a diagram showing an input image 51 divided into a plurality of divided regions 52 with inserted lines 56 inserted. According to this diagram, a total of four black inserted lines 56 extending horizontally are inserted for every three divided regions 52 in the vertical direction. The height of the inserted lines 56 is 3px. As a result, 15 divided regions 52, each 12px square, are provided vertically, and 16 are provided horizontally.

The insertion direction, width, and insertion interval of the inserted lines 56 can be set, and the preprocessing unit 21 may change the size of the input image 51 according to the settings. The preprocessing unit 21 may appropriately enlarge the input image 51 or add margins in order to insert the inserted lines 56.

In the single-color conversion process (step S35) by the single-color conversion unit 23, each of the divided regions 52 is converted into RGB single-color regions 53-55. In this single-color conversion process, the portions of the inserted lines 56 are displayed in black as they are. Therefore, the output file indicates the shape, position, size, and the color black for the inserted lines 56.

When an image with such inserted lines 56 is used, offset setting in the painting process becomes easier, and even if the plate arrangement is diagonally shifted during painting, the shift can be easily detected.

Note that while the program for operating the processor that constitutes the control unit 11 of the image conversion device 1 is stored in the storage unit 12, the storage unit 12 may take various forms. For example, the program may be recorded on a non-transitory recording medium such as a CD-ROM, and the program may be made executable when that recording medium is read by the image conversion device 1.

Furthermore, the image conversion device 1 may be implemented on the cloud and operated remotely from a user's terminal to perform the image conversion process. That is, the cloud-based image conversion device 1 may receive a raster format image from the user's terminal via a network, perform the image conversion process on that raster format image to convert it into a vector format, and transmit the converted vector format image to the user's terminal.

The present invention allows for various embodiments and modifications without departing from the broad spirit and scope of the present invention. Furthermore, the above-described embodiments are for explaining the present invention and do not limit the scope of the present invention. That is, the scope of the present invention is indicated not by the embodiments but by the claims. Various modifications made within the scope of the claims and the meaning of the invention equivalent thereto are to be considered within the scope of the present invention.

### EXPLANATION OF SYMBOLS

1 Image conversion device, 21 Preprocessing unit, 22 Division unit, 23 Single-color conversion unit, 24 Output unit, 51 Input image, 52 Divided region, 53-55 Single-color region, 56 Inserted line (Interlace)

1. An image conversion method for converting a raster format into a vector format, the image conversion method comprising:
dividing an input image in a raster format into a plurality of divided regions having a predetermined size;
using the luminance of red, green, and blue of all pixels in the divided region to calculate respective luminance averages for red, green, and blue in the divided region;
providing three single-color regions of red, green, and blue within the divided region;
changing the sizes of the single-color regions of red, green, and blue, respectively, according to the luminance averages of red, green, and blue in the divided region; and
generating and outputting an image data in a vector format using the single-color regions of red, green, and blue.

2. The image conversion method according to claim 1, wherein the vector format defines shape, size, position, and color of each single-color region.

3. The image conversion method according to claim 1, wherein, when a total average of the luminance averages of red, green, and blue in the divided region exceeds a threshold value, no single-color regions are provided in the divided region, and generating vector data that represents the entire divided region in white.

4. The image conversion method according to claim 1, wherein, when an average luminance of at least one of red, green, or blue in the divided region is below a threshold, a single-color region of any color whose average luminance is below the threshold is not provided.

5. The image conversion method according to claim 1, wherein the input image is divided into the divided regions with an inserted line with a predetermined width extending vertically or horizontally between the divided regions.

6. An image conversion device for converting a raster format into a vector format, comprising:
a division unit that divides an input image represented in a raster format into a plurality of divided regions of a predetermined size;
a single-color conversion unit that uses the luminance of red, green, and blue of all pixels in the divided region to calculate respective luminance averages for red, green, and blue in the divided region, provides three single-color regions of red, green, and blue in the divided region, and changes the sizes of the single-color regions of red, green, and blue, respectively, according to the luminance averages of red, green, and blue in the divided region; and
an output unit that generates and outputs image data in a vector format using the single-color regions of red, green, and blue.

7. A non-transitory computer-readable medium having computer-executable instructions stored thereon that, when executed by a processor, cause the processor to perform a method comprising:
dividing an input image in a raster format into a plurality of divided regions having a predetermined size;
using the luminance of red, green, and blue of all pixels in the divided region to calculate respective luminance averages for red, green, and blue in the divided region;
providing three single-color regions of red, green, and blue within the divided region;
changing the sizes of the single-color regions of red, green, and blue, respectively, according to the luminance averages of red, green, and blue in the divided region; and
generating and outputting an image data in a vector format using the single-color regions of red, green, and blue.
